(19) United States
(12) Patent Application Publication
(10) Pub. No.: US 2015/0267451 A1
(43) Pub. Date: Sep. 24, 2015

(54) HINGE DEVICE

(71) Applicant: HITACHI CHEMICAL COMPANY, LTD., Tokyo (JP)

(72) Inventor: Youji HIRAI, Tagawa-shi (JP)

(21) Appl. No.: 14/626,957

(22) Filed: Feb. 20, 2015

Related U.S. Application Data
(63) Continuation of application No. PCT/JP2014/057322, filed on Mar. 18, 2014.

(51) Int. Cl. E05F 1/12; E05D 5/02; E05D 3/02

(52) U.S. Cl. CPC E05F 1/12; E05D 3/02; E05D 5/0207

(57) ABSTRACT

In a base hinge device comprising a resin-made base hinge and a resin-made arm hinge rotatably engaging the resin-made base hinge through a rotary shaft; one of the resin-made base hinge and resin-made arm hinge having the rotary shaft, while the other having a rotary shaft bearing for pivotally supporting the rotary shaft; a biasing member arranged on the rotary shaft side and a slider arranged on the rotary shaft bearing side being interposed between the rotary shaft and rotary shaft bearing; the slider has a projection on an outer periphery thereof, the projection being adapted to be pressed at an inner periphery of the rotary shaft bearing toward the biasing member and displaced so as to be pushed in.

### TECHNICAL FIELD

The present invention relates to a hinge device of a vehicle console box equipped with a lid (lid body) which is adapted to open and close.

### BACKGROUND ART

A floor console of a car is integrally provided with a console box extending along between a driver seat and a front passenger seat and typically serving as a clutter catcher adapted to contain various small articles for driving or compact discs and the like. A lid (lid body) which covers an upper opening of the console box in an openable and closable manner may be formed as a so-called slide or shade type, but is typically formed as a lid doubling as an armrest and has a rear end joined with a hinge device (hinge) to the box body (see, for example, Patent Literatures 1 to 3).

The vehicle console box has a console box body (base body) formed into a box shape and a lid for opening and closing an opening of the console box body. One of the console box body and lid has a rotary shaft of the hinge device (hinge), while the other has a rotary shaft bearing of the hinge device (hinge) which pivotally supports the rotary shaft. Therefore, the lid revolves between an open position to open the opening and a close position to close the opening

Unless the rotary shaft bearing is molded with a high precision in this case, however, an elastic body may be caught by the rotary shaft bearing or rotary shaft, so as to increase rotary load, thereby failing to improve rotational operability fully and making it difficult to assemble the elastic body (biasing member) to the rotary shaft bearing. Hence, there have been demands for rotary devices (console boxes) which are excellent in the property of assembling the elastic body and the rotational operability, for which a rotary device (console box) improving its rotary operability by interposing a slider made of a resin material having a low coefficient of friction between the rotary shaft and rotary shaft bearing, for example, has been disclosed (see, for example, Patent Literature 4).

### CITATION LIST

### Patent Literature

Patent Literature 1: Japanese Patent Application Laid-Open No. H09-0267852

Patent Literature 2: Japanese Patent Application Laid-Open No. 2000-343935

Patent Literature 3: Japanese Patent Application Laid-Open No. 2005-349936

Patent Literature 4: Japanese Patent Application Laid-Open No. 2009-286165

### SUMMARY OF INVENTION

### Technical Problem

Assembling an elastic body (a biasing member such as a spring) in a contracted state into the rotary shaft bearing in the hinge device (hinge) of the console box has been a very cumbersome operation in manufacturing operations and raising the cost as well.

Therefore, the present invention overcomes the problem mentioned above and the like and provides a hinge device for a vehicle console box which is excellent in rotational operability and assembling workability.

### Solution to Problem

The present invention is as follows:

(1) A hinge device comprising a resin-made base hinge and a resin-made arm hinge rotatably engaging the resin-made base hinge through a rotary shaft; one of the resin-made base hinge and resin-made arm hinge having the rotary shaft, while the other having a rotary shaft bearing for pivotally supporting the rotary shaft; a biasing member arranged on the rotary shaft side and a slider arranged on the rotary shaft bearing side being interposed between the rotary shaft and rotary shaft bearing; wherein the slider has a projection on an outer peripheral surface thereof, an incision being formed about the projection, the projection being adapted to be pressed at an inner periphery of the rotary shaft bearing toward the biasing member and displaced so as to be pushed in.

(2) A hinge device according to (1), wherein the biasing member is an elastic member.

(3) A hinge device according to (1) or (2), wherein the slider is made of a resin.

### Advantageous Effects of Invention

The present invention can provide a hinge device for a vehicle console box which is excellent in rotational operability and assembling workability.

### BRIEF DESCRIPTION OF DRAWINGS

FIG. 1 is a perspective view illustrating a console box as a vehicle interior part;

FIG. 2 is an exploded view illustrating the hinge device in accordance with an embodiment of the present invention;

FIGS. 3A and 3B are plan views illustrating respective states where a biasing member is arranged within a slider and where the slider is arranged within a rotary shaft bearing in the hinge device in accordance with the embodiment of the present invention;

FIG. 4A is a sectional view taken along the line a-a of FIG. 3B, while FIG. 4B is a partly sectional view of a state where the rotary shaft is inserted;

FIGS. 5A and 5B are perspective views of the hinge device in accordance with the embodiment of the present invention as observed from the bottomed side and opening side of the slider, respectively;

FIG. 6 is a side view of the slider in the hinge device in accordance with the embodiment of the present invention; and

FIGS. 7A and 7B are sectional views taken along the lines A-A′ and B-B′ of FIG. 6, respectively.

### DESCRIPTION OF EMBODIMENTS

An embodiment in which the hinge device of the present invention is used in a console box serving as a vehicle interior part will now be explained.

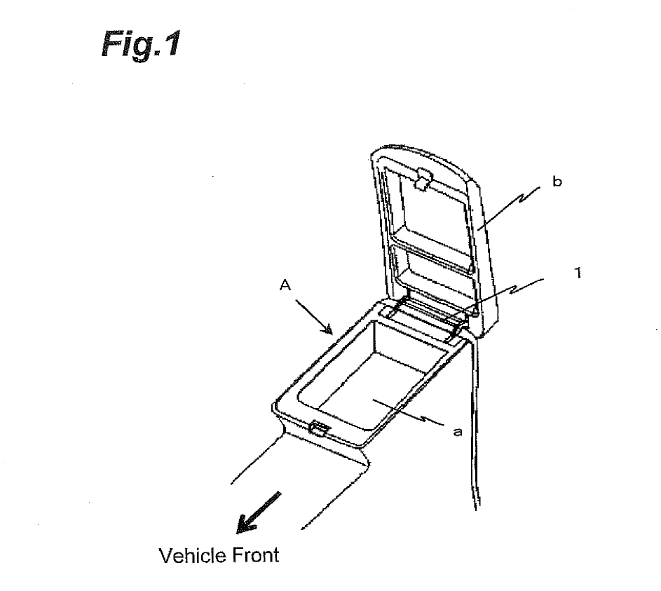

FIG. 1 illustrates a perspective view of a part of a console box A as a vehicle interior part using the hinge device of this embodiment. This console box A comprises a container a for containing small articles and the like therein and a lid (lid body) b adapted to revolve thereon through a hinge device 1. Constructed on the upper face of the lid (lid body) b, for example, is an armrest for a driver of the vehicle to put an arm on, which is formed as a part of a center console covering a shift lever and disposed along between a driver seat and a front passenger seat.

In this console box A, a rear end part of the lid b is typically attached to the rear end of the console box body as being pivotally supported by the hinge device 1 of the present invention, while the lid b is held at any position by the hinge device 1 of the present invention as will be explained later.

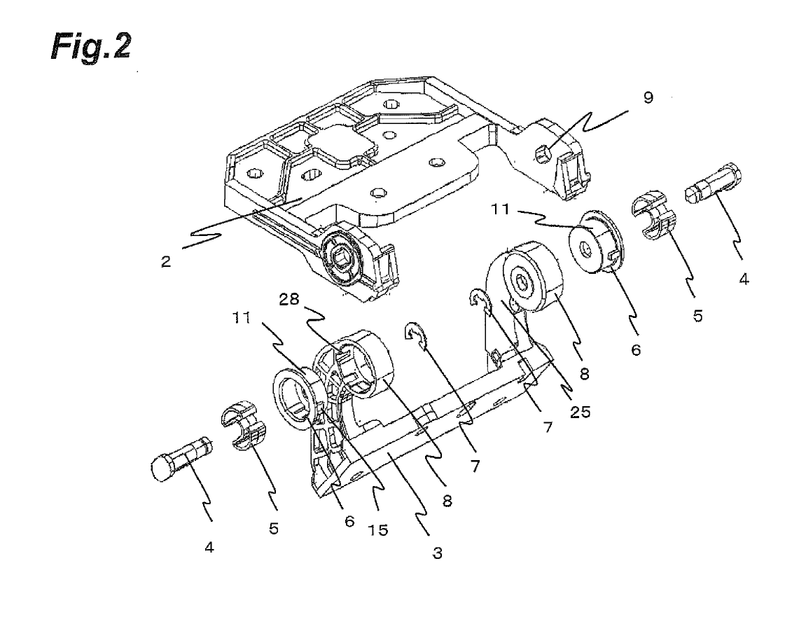

FIG. 2 is an exploded view of the hinge device 1 of this embodiment.

The hinge device 1 of this embodiment is a hinge device 1 comprising a resin-made base hinge 3 and a resin-made arm hinge 2 rotatably engaging the resin-made base hinge 3 through rotary shafts 4; one of the resin-made base hinge 3 and resin-made arm hinge 2 being held by the rotary shafts 4, while the other having rotary shaft bearings 8 for pivotally supporting the rotary shafts 4; a biasing member 5 arranged on the rotary shaft 4 side and a slider 6 arranged on the rotary shaft bearing 8 side being interposed between the rotary shaft 4 and rotary shaft bearing 8; in which the slider 6 has a projection on an outer peripheral surface 11 thereof, incisions being formed about the projection, the projection being adapted to be pressed at an inner periphery of the rotary shaft bearing 8 toward the biasing member 5 and displaced so as to be pushed in.

The projection is formed on the outer peripheral surface 11 of the slider 6 so as to project outward, while the incisions reaching from the outside of the slider 6 to the inside thereof are formed about the projection. The presence of the incisions enables the projection to be displaced by external pressures. Therefore, the projection may have any two-dimensional form such as circles and polygons without being restricted in particular as long as it is formed so as to project outward. It is sufficient for the incisions about the projection to be formed to such an extent that the projection can be displaced by an external pressure; for example, assuming that the surrounding length of the projection is 100%, the length of the incisions may be on the order of 50 to 90% thereof

The projection is provided at one location or two or more locations on the outer peripheral surface 11 of the slider 6. The biasing member 5 is preferably an elastic member, while the slider 6 is more preferably made of a resin. This embodiment uses resins and reduces weight, so that components can be cut down, whereby the hinge device 1 becomes excellent in workability and practicability.

The resin-made base hinge 3 is molded from a plastic resin and disposed on the side of a secured member serving as a base. The resin-made arm hinge 2 is molded from a plastic resin and provided on the side of a member rotatably attached to the member serving as a base. The plastic resin is not restricted in particular as long as it is moldable, and its examples include polyethylene, polypropylene, polyvinyl chloride, polystyrene, acrylonitrile-butadiene-styrene resin, acrylic resin, polyimide resin, and polyamide resin.

While the hinge device 1 of this embodiment comprises the resin-made base hinge 3 and the resin-made arm hinge 2 rotatably engaging the resin-made base hinge 3, the resin-made base hinge 3 and the resin-made arm hinge 2 rotatably engage each other through the rotary shafts 4.

As illustrated in FIG. 2, for example, the resin-made arm hinge 2 is provided with attachment holes 9 for inserting rotary shafts, the resin-made base hinge 3 and resin-made arm hinge 2 are assembled together, the rotary shafts 4 are inserted into the attachment holes 9 of the resin-made arm hinge 2 for inserting the rotary shafts and the biasing members 5 disposed within the rotary shaft bearings 8 of the resin-made base hinge 3, and rings 7 and the like are fitted onto the rotary shafts 4 so as to keep the rotary shafts 4 from dropping out, whereby the resin-made base hinge 3 and resin-made arm hinge 2 rotatably engage each other through the rotary shafts 4.

The biasing member 5 and slider 6 are typically arranged within each rotary shaft bearing 8 before assembling the resin-made base hinge 3 and resin-made arm hinge 2 together. Ribs 15 are provided on the outer peripheral surface of the slider 6 and enter their corresponding groove parts 28 formed in the inner peripheral surface of the rotary shaft bearing 8 located at the leading end of each arm 25 of the resin-made base hinge 3.

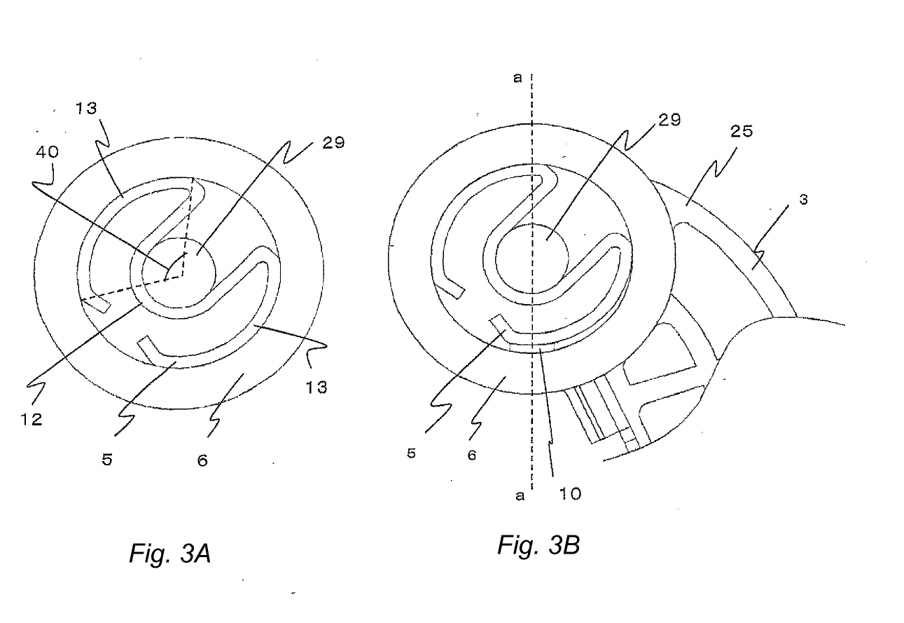

As illustrated in FIG. 3A, the biasing member 5 and slider 6 are arranged within each rotary shaft bearing 8 before assembling the resin-made base hinge 3 and resin-made arm hinge 2 together. The slider 6 is made of a resin, which is preferably polyacetal resin from the viewpoint of strength and durability, and has a bottomed substantially perfect cylindrical form provided with an attachment hole 29 for inserting the rotary shaft. The biasing member 5 is an elastic body, an example of which is a metal leaf spring having a curved belt form.

Each of attachment parts 12 for the rotary shafts 4, which is a substantially center part of the metal leaf spring (biasing member), is curved into a substantially perfect circular arc. Each of two slidable parts 13 located on both end sides of the attachment part in the metal leaf spring (biasing member) is curved into a substantially perfect circular arc.

As illustrated in FIG. 3B, the slider 6 having the biasing member 5 arranged therein is assembled into the rotary shaft bearing (not depicted) of the resin-made base hinge 3, so that a projection 10 of the slider 6 is pressed at the inner periphery of the rotary shaft bearing and displaced so as to be pushed in, whereby a part of the projection 10 having incisions thereabout projects inward (toward the biasing member 5) and intrudes, thus coming into contact with the biasing member 5 somewhat strongly.

Therefore, the projection 10 may be provided on the outer peripheral surface of the slider 6 so as to abut against the biasing member 5 (leaf spring or the like) within a range in which the resin-made base hinge 3 and resin-made arm hinge 2 freely revolve about each other through the rotary shaft 4. For keeping a constant frictional force (sliding) between the biasing member 5 (leaf spring or the like) and slider 6, the biasing member 5 may be installed at a position where the projection 10 and biasing member 5 (leaf spring or the like) do not abut against each other. In order for the frictional force (sliding) between the biasing member 5 (leaf spring or the like) and slider 6 to become greater when the lid (lid body) of the console box is fully open, the biasing member 5 (leaf spring or the like) may be installed or the projection 10 may be provided at a position where the projection 10 and biasing member 5 (leaf spring or the like) do not abut against each other when the lid (lid body) of the console box is fully open.

On the circumference of the inner peripheral surface of the slider 6, one of the slidable parts 13 of the biasing member 5 (leaf spring or the like) preferably has a center angle 40 of at least 80° but not greater than 160°. This makes the projection 10 and biasing member 5 abut against each other within the range in which the resin-made base hinge and resin-made base hinge revolve about each other.

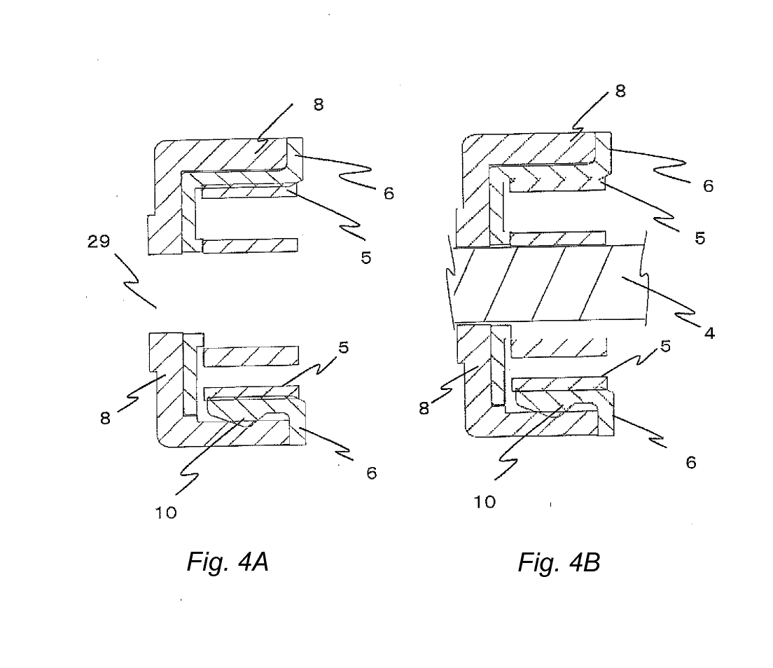

FIG. 4A is a sectional view taken along the line a-a of FIG. 3B. As illustrated in FIG. 4A, the slider 6 and biasing member 5 are arranged in the rotary shaft bearing 8 of the resin-made base hinge 3, while a part of the projection 10 having incisions formed thereabout in the slider 6 is in contact with the biasing member 5. Since a part of the projection 10 having incisions formed thereabout in the slider 6 is in contact with the biasing member 5 somewhat strongly, the biasing member 5 comes into slidable contact with the slider 5 more elastically.

While the biasing member 5 is arranged within the slider 6 beforehand, the inner diameter of the slider 6 is substantially the same as the diameter of the biasing member 5, which makes it easy for the biasing member 5 to enter the slider 6 so as to be arranged therein.

In FIG. 4B which is a partly sectional view of a state where the rotary shaft 4 is inserted (not depicting the resin-made arm hinge and the like), between the rotary shaft 4 and rotary shaft bearing 8, the biasing member 5 is arranged on the rotary shaft 4 side, while the slider 6 is arranged on the rotary shaft bearing 8 side. That is, the above-mentioned arrangement makes it possible to secure the slider 6 to the rotary shaft bearing 8 and bring the biasing member 5 into slidable contact with the slider 6.

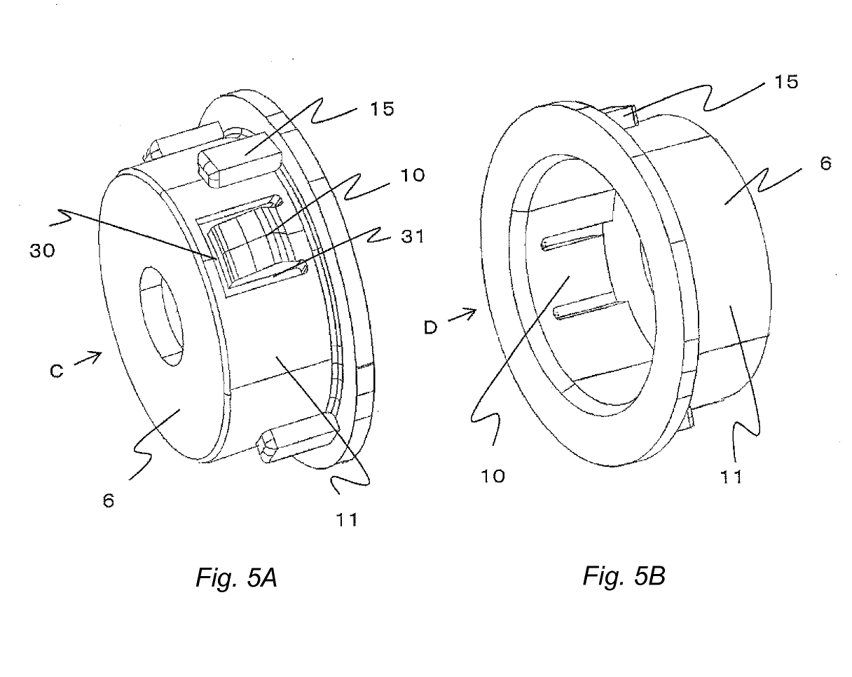

FIG. 5A is a perspective view of the slider 6 as observed from its bottomed side C, while FIG. 5B is a perspective view of the slider 6 as observed from its opening side D. The slider 6 has the projection 10 on its outer peripheral surface 11, while the projection 10 has incisions 30, 31 formed thereabout which enable it to be pressed and displaced so as to be pushed in.

The slider 6 also has the ribs 15 provided on its outer peripheral surface. Since the ribs 15 of the slider 6 enter their corresponding groove parts formed in the inner peripheral surface of the rotary shaft bearing 8, the slider 6 is secured to the rotary shaft bearing 8.

It is preferred to provide a plurality of the ribs 15 from the viewpoint of load balancing, though their number is not restricted. When two ribs 15 are provided, it is preferable for them to be positioned symmetrical to each other about the center of the slider 6. When three or more ribs 15 are provided, it is preferred that two of them be positioned symmetrical to each other, and the third and later ones be positioned asymmetrical to the two ribs 15 from the viewpoint of preventing misassembly.

While the ribs 15 of the slider 6 enter the groove parts (not depicted) formed in the inner peripheral surface of the rotary shaft bearing (not depicted), so that the slider 6 is secured to the rotary shaft bearing, it is preferred that at least one of the groove parts be provided in a thick part of the rotary shaft bearing near an arm (not depicted) of the resin-made base hinge (not depicted).

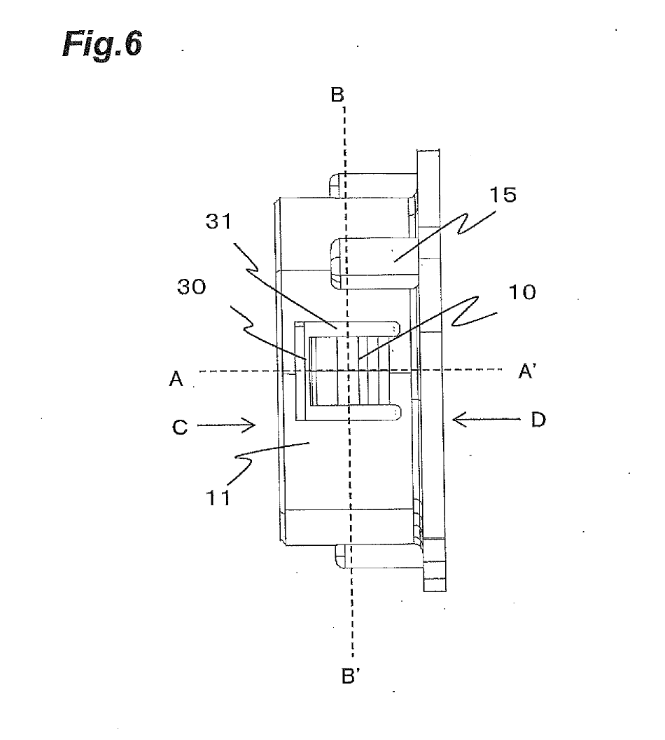

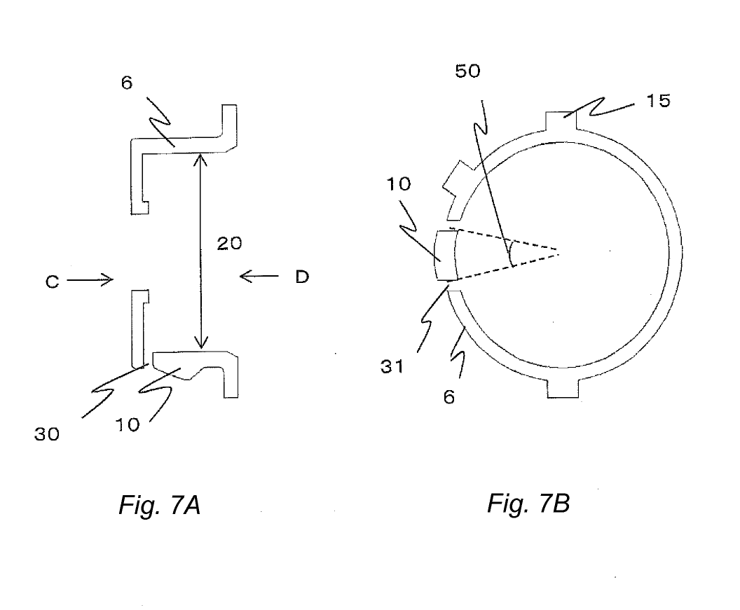

FIG. 6 is a side view of the slider 6, while FIGS. 7A and 7B are sectional views taken along the lines A-A′ and B-B′ of FIG. 6, respectively.

When projections 10 are provided at two or more locations, it is preferred for them to be disposed at equal angular intervals on the outer peripheral surface of the slider 6. On the circumference of the outer peripheral surface of the slider 6, one projection 10 preferably has a center angle 50 of at least 30° but not greater than 180°, more preferably at least 60° but not greater than 160°, particularly preferably at least 90° but not greater than 120°. This enables the projection 10 and the biasing member (not depicted) to abut against each other within the range in which the resin-made base hinge and resin-made base hinge revolve about each other.

As mentioned above, the slider 6 has an inner diameter 20 which is substantially the same as or slightly smaller or larger than the diameter of the biasing member. Therefore, the operation of causing the biasing member to enter the slider 6 from the opening side D is easy.

The projection 10 of the slider 6 is formed with incisions thereabout in three directions, i.e., an incision 30 on the bottomed side C of the slider 6 and a pair of incisions 31 in a direction perpendicular to the former incision. The height of the projection 10 is lower on the bottomed side C and gradually increases to the opening side D. Therefore, even when the biasing member is arranged in the slider 6, the projection 10 projects only a little to the outer peripheral surface 11, whereby the operation of causing the slider 6 to enter the rotary shaft bearing 8 is easy.

Arranging the slider 6 in the rotary shaft bearing 8 causes the projection 10 having the incisions 30, 31 thereabout to be pressed at the inner periphery of the rotary shaft bearing 8 and displaced so as to be pushed in, whereby a part of the projection (on the rear face side) abuts against the biasing member, which makes the biasing member come into slidable contact with the slider 6 elastically.

### REFERENCE SIGNS LIST

A: console box; a: container; b: lid or lid body; 1: hinge device; 2: resin-made arm hinge; 3: resin-made base hinge; 4: rotary shaft; 5: biasing member; 6: slider; 7: ring; 8: rotary shaft bearing; 9: attachment hole for inserting the rotary shaft; 10: projection (having incisions); 11: outer peripheral surface of the slider; 12: attachment part; 13: slidable part; 15: rib; 20: inner diameter of the slider; 25: arm of the resin-made base hinge; 28: groove part; 29: attachment hole for inserting the rotary shaft; 40: center angle (corresponding to the slidable part); 50: center angle (corresponding to the projection); 30, 31: incision; C: bottomed side of the slider; D: opening side of the slider.

1. A hinge device comprising a resin-made base hinge and a resin-made arm hinge rotatably engaging the resin-made base hinge through a rotary shaft;
one of the resin-made base hinge and resin-made arm hinge having the rotary shaft, while the other having a rotary shaft bearing for pivotally supporting the rotary shaft;
a biasing member arranged on the rotary shaft side and a slider arranged on the rotary shaft bearing side being interposed between the rotary shaft and rotary shaft bearing;
wherein the slider has a projection on an outer peripheral surface thereof, an incision being formed about the projection, the projection being adapted to be pressed at an inner periphery of the rotary shaft bearing toward the biasing member and displaced so as to be pushed in.

2. A hinge device according to claim 1, wherein the biasing member is an elastic member.

3. A hinge device according to claim 1, wherein the slider is made of a resin.
